(19) United States
(12) Patent Application Publication
(10) Pub. No.: US 2022/0358851 A1
(43) Pub. Date: Nov. 10, 2022

(54) GENERATING QUESTION ANSWER PAIRS

(71) Applicant: International Business Machines Corporation, Armonk, NY (US)

(72) Inventors: Dakuo Wang, Cambridge, MA (US); Mo Yu, White Plains, NY (US); Chuang Gan, Cambridge, MA (US); Saloni Potdar, Arlington, MA (US)

(21) Appl. No.: 17/302,550

(22) Filed: May 6, 2021

(51) Int. Cl. G09B 7/02; G06N 3/08; G06F 16/332; G06F 16/33; G06F 16/35; G06F 40/10

(52) U.S. Cl. CPC G09B 7/02; G06N 3/08; G06F 16/3329; G06F 16/3347; G06F 16/35; G06F 40/10

(57) ABSTRACT

In an approach to generating question answer pairs, one or more computer processors receive a corpus of text. One or more computer processors extract one or more key concepts from the corpus of text. Based on the one or more key concepts, one or more computer processors generate one or more questions associated with the key concepts, where the one or more key concepts are answers to the one or more generated questions. One or more computer processors display the one or more generated questions and the answers to the one or more generated questions.

### BACKGROUND OF THE INVENTION

The present invention relates generally to the field of artificial intelligence, and more particularly to generating question answer pairs.

Deep learning is a branch of machine learning based on a set of algorithms that model high-level abstractions in data by using model architectures, with complex structures or otherwise, often composed of multiple non-linear transformations. Deep learning is part of a broader family of machine learning methods based on learning representations of data. An observation (e.g., an image) can be represented in many ways such as a vector of intensity values per pixel, or in a more abstract way as a set of edges, regions of particular shape, etc. Some representations make it easier to learn tasks (e.g., face recognition or facial expression recognition) from examples. Deep learning algorithms often use a cascade of many layers of nonlinear processing units for feature extraction and transformation. Each successive layer uses the output from the previous layer as input. The algorithms may be supervised or unsupervised, and applications include pattern analysis (unsupervised) and classification (supervised).

An artificial neural network, often called an artificial neural net or neural net, is used in many applications to recognize a pattern or a function for which the neural net has been trained to recognize. An artificial neural network is a lattice of individual artificial neurons that are connected to each other. The artificial neurons are often arranged in layers in a lattice with the outputs of the neurons in a layer connected to the inputs of the neurons in a next layer. An artificial neuron is modeled on a biological neuron, which is comprised of dendrites that carry input signals (often originating in the outputs of other neurons) to a cell body that processes the inputs and produces an output signal on an axon. The signal on the axon is often an input to one or more synapses that each provide a connection to one or more dendrites (inputs) on other neurons.

It has been noted that optimal learning by young children occurs when the children interact socially through meaningful conversation. Young children can learn how to read, learn new languages, and improve social interaction skills through being read to, such as during bedtime storybook reading. Storybook reading can be more impactful to a child's learning if the reading is accompanied by interactive questions and answers. Yet it may be difficult for a person reading to a child to come up with questions to ask based on the text.

### SUMMARY

A first aspect of the present invention discloses a method including one or more computer processors receiving a corpus of text. One or more computer processors extract one or more key concepts from the corpus of text. Based on the one or more key concepts, one or more computer processors generate one or more questions associated with the key concepts, where the one or more key concepts are answers to the one or more generated questions. One or more computer processors display the one or more generated questions and the answers to the one or more generated questions. The present invention has the advantage of generating question answer pairs for corpora that include long sentences, such as storybooks, as the input, and does not rely on the input being short text or singular sentences.

A second aspect of the present invention discloses a computer program product including one or more computer readable storage media and program instructions collectively stored on the one or more computer readable storage media. The stored program instructions include program instructions to receive a corpus of text. The stored program instructions include program instructions to extract one or more key concepts from the corpus of text. Based on the one or more key concepts, the stored program instructions include program instructions to generate one or more questions associated with the key concepts, where the one or more key concepts are answers to the one or more generated questions. The stored program instructions include program instructions to display the one or more generated questions and the answers to the one or more generated questions.

A third aspect of the present invention disclose a computer system including one or more computer processors and one or more computer readable storage media, where program instructions are collectively stored on the one or more computer readable storage media. The stored program instructions include program instructions to receive a corpus of text. The stored program instructions include program instructions to extract one or more key concepts from the corpus of text. Based on the one or more key concepts, the stored program instructions include program instructions to generate one or more questions associated with the key concepts, where the one or more key concepts are answers to the one or more generated questions. The stored program instructions include program instructions to display the one or more generated questions and the answers to the one or more generated questions.

In another aspect, the present invention discloses a method including one or more computer processors extracting the one or more key concepts from the corpus of text based on a pedagogical template. An advantage of extracting key concepts based on a pedagogical template is that corpora from a domain-independent collection are treated consistently. Another advantage of extracting key concepts based on a pedagogical template is that the key concepts, and subsequently the generated questions, are categorized for teaching.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a question answer generation program, on a server computer within the distributed data processing environment of FIG. 1, for generating question answer pairs, in accordance with an embodiment of the present invention;

FIG. 3A illustrates an example of the operation of the question answer generation program, as displayed by a user interface, on a client computing device within the distributed data processing environment of FIG. 1, in accordance with an embodiment of the present invention;

FIG. 3B illustrates another example of the operation of the question answer generation program, as displayed by the user interface, on the client computing device within the distributed data processing environment of FIG. 1, in accordance with an embodiment of the present invention; and

FIG. 4 depicts a block diagram of components of the server computer executing the question answer generation program within the distributed data processing environment of FIG. 1, in accordance with an embodiment of the present invention.

### DETAILED DESCRIPTION

Embodiments of the present invention recognize that efficiency may be gained by providing a system that can parse the text of a storybook, or other document, and generate question answer pairs for use with a conversational agent. Embodiments of the present invention also recognize that generated question answer pairs that meet a pedagogical guideline can be valuable for early education. Implementation of embodiments of the invention may take a variety of forms, and exemplary implementation details are discussed subsequently with reference to the Figures.

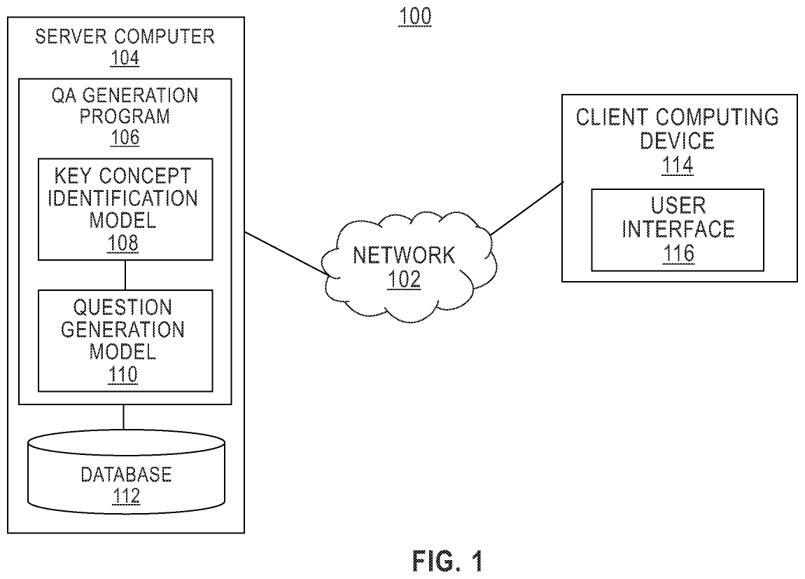

FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server computer 104 and client computing device 114 interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks capable of receiving and transmitting data, voice, and/or video signals, including multimedia signals that include voice, data, and video information. In general, network 102 can be any combination of connections and protocols that will support communications between server computer 104, client computing device 114, and other computing devices (not shown) within distributed data processing environment 100.

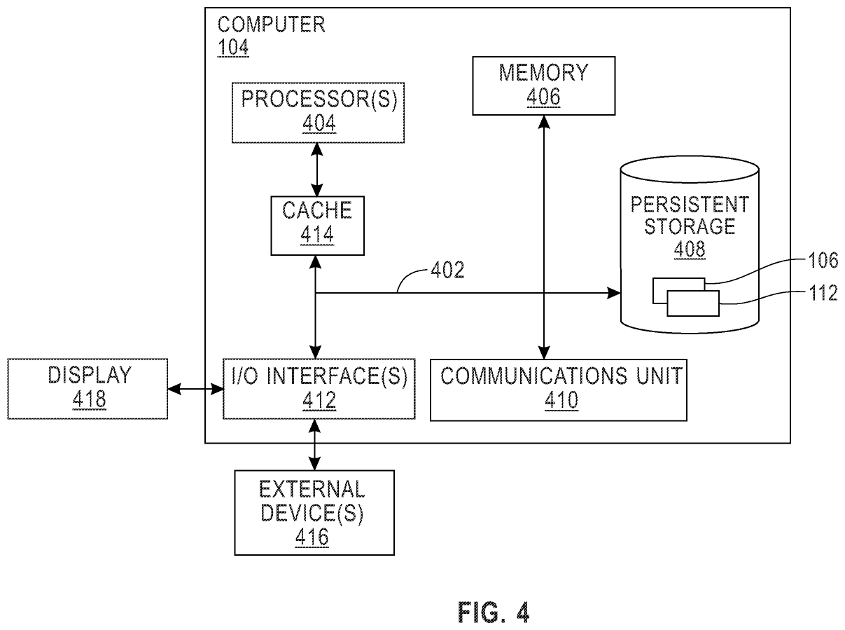

Server computer 104 can be a standalone computing device, a management server, a web server, a mobile computing device, or any other electronic device or computing system capable of receiving, sending, and processing data. In other embodiments, server computer 104 can represent a server computing system utilizing multiple computers as a server system, such as in a cloud computing environment. In another embodiment, server computer 104 can be a laptop computer, a tablet computer, a netbook computer, a personal computer (PC), a desktop computer, a personal digital assistant (PDA), a smart phone, or any programmable electronic device capable of communicating with client computing device 114 and other computing devices (not shown) within distributed data processing environment 100 via network 102. In another embodiment, server computer 104 represents a computing system utilizing clustered computers and components (e.g., database server computers, application server computers, etc.) that act as a single pool of seamless resources when accessed within distributed data processing environment 100. Server computer 104 includes question answer (QA) generation program 106 and database 112. Server computer 104 may include internal and external hardware components, as depicted and described in further detail with respect to FIG. 4.

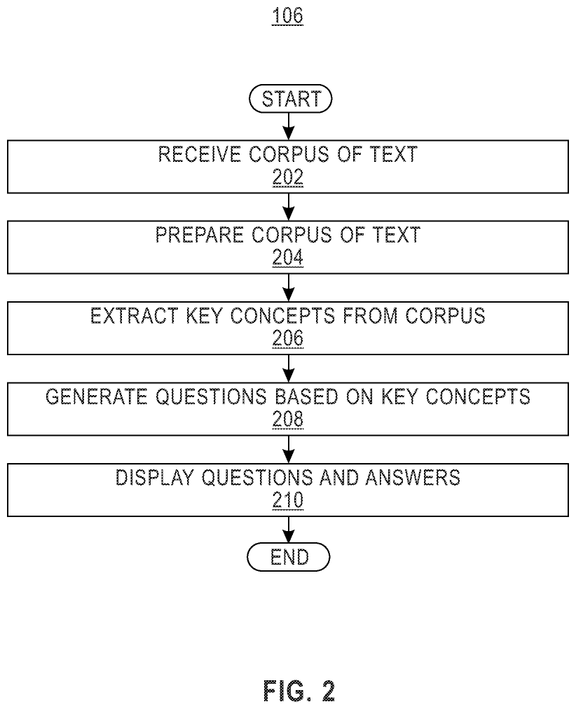

Question answer (QA) generation program 106 provides a deep learning architecture for a system that automatically generates question and answer pairs for an input text through an answer-oriented, two step approach. QA generation program 106 receives a corpus of text. QA generation program 106 prepares the corpus of text. QA generation program 106 parses the corpus of text and extracts key concepts. QA generation program 106 generates questions based on the key concepts. QA generation program 106 displays the questions and associated answers. QA generation program 106 includes key concept identification model 108 and question generation model 110. QA generation program 106 is depicted and described in further detail with respect to FIG. 2.

Key concept identification model 108 is responsible for extracting key concepts from a provided corpus of text, such as a storybook, that will be the basis of answers to questions about the corpus. In an embodiment, key concept identification model 108 extracts key concepts based on a pedagogical template, i.e., an outline or structure used for teaching, as would be recognized by a person of skill in the art. For example, the pedagogical template for teaching with a storybook may include categories such as character, setting, feeling, action, causal relationship, outcome resolution, and prediction. An advantage of extracting key concepts based on a pedagogical template is that corpora from a domain-independent collection are treated consistently. Another advantage of extracting key concepts based on a pedagogical template is that the key concepts, and subsequently the generated questions, are categorized for teaching. Key concept identification model 108 ingests the received corpus and parses the text into keywords and key phrases that fit into one or more of the pedagogical categories. In an embodiment, a user of client computing device 114 trains key concept identification model 108 by supplying labelled question and answer pairs, via user interface 116, to database 112. For example, if a line in a book reads “the other ducks preferred swimming in the moat,” then training data for key concept identification model 108 includes the category, “setting,” the question “where did the other ducks prefer swimming?” and the answer “the moat.” In an embodiment, key concept identification model 108 is comprised of two or more sub-models. In an embodiment, the self-labelling of corpus keywords and key phrases is performed by a classification model. In an embodiment, the training data for key concept identification model 108 is processed through a bidirectional long short term memory (LSTM) model, as would be recognized by a person of skill in the art. In an embodiment, the training data is split, and for example, 80 percent of the data is used for training and 20 percent of the data is used for testing. In the depicted embodiment, key concept identification model 108 is a separate component of QA generation program 106. In another embodiment, the function of key concept identification model 108 is fully integrated into QA generation program 106.

Question generation model 110 functions as an autoencoder for QA generation program 106. As would be recognized by a person of skill in the art, an autoencoder is a type of artificial neural network executed to learn efficient data codings in an unsupervised manner. The aim of an autoencoder is to learn a representation (encoding) for a set of data, typically for dimensionality reduction, by training the network to ignore signal “noise”. Along with the reduction side, a reconstructing side is learned, where the autoencoder tries to generate, from the reduced encoding, a representation as close as possible to its original input. Autoencoders include two components: an encoder and a decoder. The encoder encodes, for example, an input row of a table into a vector representation, sometimes referred to as an embedded vector. The decoder tries to reconstruct the original row of the table from the embedded vector. Neural networks with learnable parameters can be used as encoders and decoders. The neural networks are trained to minimize the reconstruction errors; therefore, the embedded vector is a compression of the input row of a table. In an embodiment, question generation model 110 includes a bidirectional encoder and an autoregressive decoder. The bidirectional encoder reads in the list of key concepts extracted by key concept identification model 108. The bidirectional encoder then passes the key concepts to the autoregressive decoder. The autoregressive decoder outputs at least one sentence, i.e., question, associated with each key concept, i.e., answer. For example, question generation model 110 receives the term “the moat” and generates the question “where did the other ducks prefer swimming?” In the depicted embodiment, question generation model 110 is a separate component of QA generation program 106. In another embodiment, the function of question generation model 110 is fully integrated into QA generation program 106.

In the depicted embodiment, database 112 resides on server computer 104. In another embodiment, database 112 may reside elsewhere within distributed data processing environment 100, provided that QA generation program 106 has access to database 112. A database is an organized collection of data. Database 112 can be implemented with any type of storage device capable of storing data and configuration files that can be accessed and utilized by QA generation program 106, such as a database server, a hard disk drive, or a flash memory. Database 112 stores information used and generated by QA generation program 106. Database 112 stores one or more text documents submitted by a user of client computing device 114. In an embodiment, the text documents include one or more storybooks. Database 112 also stores one or more question answer pairs generated by QA generation program 106. Database 112 also stores training data for key concept identification model 108.

The present invention may contain various accessible data sources, such as database 112, that may include personal data, content, or information the user wishes not to be processed. Personal data includes personally identifying information or sensitive personal information as well as user information, such as tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. QA generation program 106 enables the authorized and secure processing of personal data. QA generation program 106 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. QA generation program 106 provides information regarding personal data and the nature (e.g., type, scope, purpose, duration, etc.) of the processing. QA generation program 106 provides the user with copies of stored personal data. QA generation program 106 allows the correction or completion of incorrect or incomplete personal data. QA generation program 106 allows the immediate deletion of personal data.

Client computing device 114 can be one or more of a laptop computer, a tablet computer, a smart phone, smart watch, a smart speaker, or any other programmable electronic device capable of communicating with various components and devices within distributed data processing environment 100, via network 102. Client computing device 114 may be a wearable computer. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In one embodiment, the wearable computer may be in the form of a head mounted display. The head mounted display may take the form-factor of a pair of glasses. In an embodiment, the wearable computer may be in the form of a smart watch. In an embodiment, client computing device 114 may be integrated into a vehicle of the user. For example, client computing device 114 may include a heads-up display in the windshield of the vehicle. In general, client computing device 114 represents one or more programmable electronic devices or combination of programmable electronic devices capable of executing machine readable program instructions and communicating with other computing devices (not shown) within distributed data processing environment 100 via a network, such as network 102. Client computing device 114 includes an instance of user interface 116.

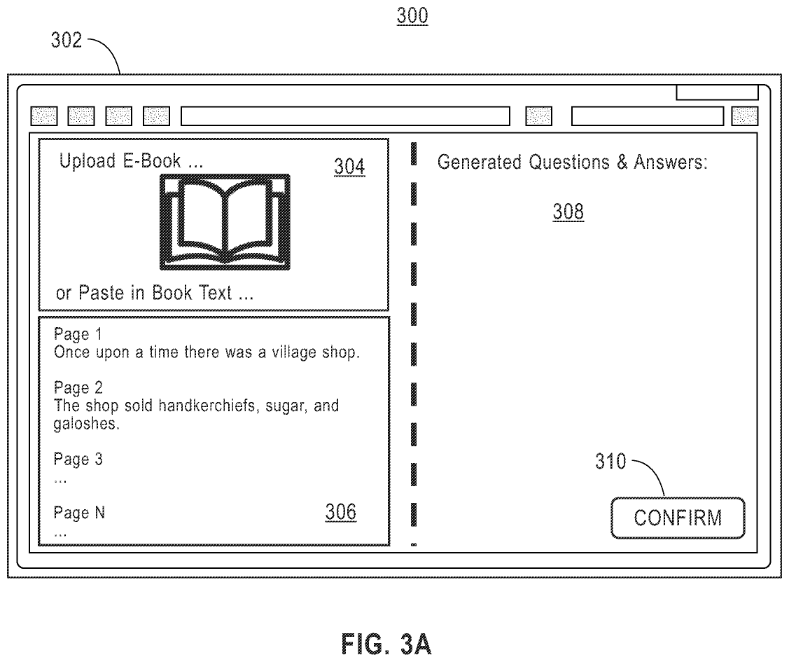

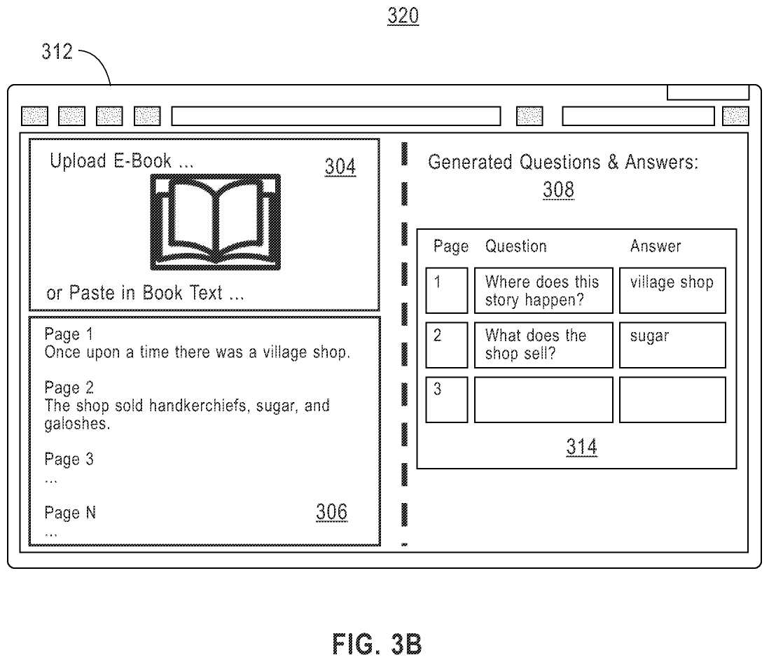

User interface 116 provides an interface between QA generation program 106 on server computer 104 and a user of client computing device 114. In one embodiment, user interface 116 is mobile application software. Mobile application software, or an “app,” is a computer program designed to run on smart phones, tablet computers and other mobile devices. In one embodiment, user interface 116 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. User interface 116 enables a user of client computing device 114 to provide a corpus of text, such as a storybook, for which QA generation program 106 generates question answer pairs. User interface 116 also enables a user of client computing device 114 to receive the question answer pairs generated by QA generation program 106. In addition, user interface 116 enables a user of client computing device 114 to input training data for key concept identification model 108. User interface 116 is depicted and described in further detail with respect to FIGS. 3A and 3B.

FIG. 2 is a flowchart depicting operational steps of question answer generation program 106, on server computer 104 within distributed data processing environment 100 of FIG. 1, for generating question answer pairs, in accordance with an embodiment of the present invention.

QA generation program 106 receives a corpus of text (step 202). In an embodiment, QA generation program 106 receives a corpus of text from the user of client computing device 114, via user interface 116. For example, QA generation program 106 receives the corpus when the user of client computing device 114 pastes the text of a book into user interface 116. In another example, QA generation program 106 receives a corpus of text when the user of client computing device 114 uploads an electronic book, i.e., an e-book. In another embodiment, the user of client computing device 114 stores a corpus of text in database 112, via user interface 116, and QA generation program 106 retrieves the corpus from database 112.

QA generation program 106 prepares the corpus (step 204). In an embodiment, QA generation program 106 performs one or more operations on the corpus in order to prepare the corpus for further processing. For example, QA generation program 106 parses the corpus into individual pages, into chapters, or into sections of pages, such as ten pages. In an embodiment, QA generation program 106 determines the size of sections for parsing based on available computing resources. In another example, QA generation program 106 cleans the corpus, i.e., puts the corpus into a particular format, such that the corpus is directly useable by QA generation program 106.

QA generation program 106 extracts one or more key concepts from the corpus (step 206). In an embodiment, QA generation program 106 uses key concept identification model 108 to extract key concepts from the corpus. In an embodiment, QA generation program 106 feeds the parsed, cleaned corpus into key concept identification model 108, and key concept identification model 108 identifies one or more key concepts. As discussed earlier, key concept identification model 108 extracts key concepts based on a pedagogical template, such as categories including character, setting, feeling, action, causal relationship, outcome resolution, and prediction. For example, if a sentence in the corpus reads “once upon a time, there was a village shop that sold handkerchiefs, sugar, and galoshes,” then key concept identification model 108 extracts the key concepts of “village shop,” “handkerchiefs,” “sugar,” and “galoshes.”

QA generation program 106 generates one or more questions based on the key concepts (step 208). QA generation program 106 uses the extracted key concepts as answers to potential questions. In an embodiment, QA generation program 106 uses question generation model 110 to generate questions for which the extracted key concepts are the answers. Continuing the previous example, question generation model 110 generates the question “what does the village shop sell?” in association with the key concepts of “village shop,” “handkerchiefs,” “sugar,” and “galoshes” associated with the “setting” category. Using both the questions and the answers, QA generation program 106 generates question answer pairs. An advantage of the embodiment is that QA generation program 106 generates question answer pairs for corpora that include long sentences, such as storybooks, as the input, and does not rely on the input being short text or singular sentences. In an embodiment, QA generation program 106 repeats steps 206 and 208 for each page or section of the corpus until question answer pairs are generated for the complete corpus.

QA generation program 106 displays the questions and answers (step 210). In an embodiment, QA generation program 106 displays the question answer pairs via user interface 116. In an embodiment, a user can use the question answer pairs to ask questions of a person that is reading the corpus of text. For example, if a child is reading a storybook, a user can ask the questions of the child, and know the correct answers are the answers provided in the question answer pairs. In another embodiment, QA generation program 106 feeds the question answer pairs to a chatbot, or other conversational agent, such that the chatbot can interact with the person reading the corpus of text.

FIG. 3A illustrates example 300 of the operation of QA generation program 106, as displayed by user interface 116, on client computing device 114 within distributed data processing environment 100 of FIG. 1, in accordance with an embodiment of the present invention.

FIG. 3A includes user interface display screen 302. User interface display screen 302 includes instruction box 304, which instructs the user to either upload an e-book or paste in book text, i.e., a corpus of text, as described with respect to step 202 of FIG. 2. Text box 306 shows the text of the book, listed by page number, after QA generation program 106 has received the corpus of text. Generated questions and answers area 308 is currently empty. Confirm button 310 is for the user of client computing device 114 to press, tap, or click to trigger QA generation program 106 to generate question answer pairs for the corpus of text.

FIG. 3B illustrates example 320 of the operation of QA generation program 106, as displayed by user interface 116, on client computing device 114 within distributed data processing environment 100 of FIG. 1, in accordance with an embodiment of the present invention.

FIG. 3B also includes user interface display screen 312. User interface display screen 312 also includes instruction box 304, text box 306, and generated questions and answers area 308, similar to user interface display screen 302 of FIG. 3A. In FIG. 3B, however, generated questions and answers area 308 includes results box 314. Results box 314 lists question answer pairs, by page number, of the text from text box 306. As discussed with respect to step 210 of FIG. 2, subsequent to extracting key concepts and generating associated questions, QA generation program 106 displays the questions and answers.

FIG. 4 depicts a block diagram of components of server computer 104 within distributed data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Server computer 104 can include processor(s) 404, cache 414, memory 406, persistent storage 408, communications unit 410, input/output (I/O) interface(s) 412 and communications fabric 402. Communications fabric 402 provides communications between cache 414, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM). In general, memory 406 can include any suitable volatile or non-volatile computer readable storage media. Cache 414 is a fast memory that enhances the performance of processor(s) 404 by holding recently accessed data, and data near recently accessed data, from memory 406.

Program instructions and data used to practice embodiments of the present invention, e.g., QA generation program 106 and database 112, are stored in persistent storage 408 for execution and/or access by one or more of the respective processor(s) 404 of server computer 104 via cache 414. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of client computing device 114. In these examples, communications unit 410 includes one or more network interface cards. Communications unit 410 may provide communications through the use of either or both physical and wireless communications links. QA generation program 106, database 112, and other programs and data used for implementation of the present invention, may be downloaded to persistent storage 408 of server computer 104 through communications unit 410.

I/O interface(s) 412 allows for input and output of data with other devices that may be connected to server computer 104. For example, I/O interface(s) 412 may provide a connection to external device(s) 416 such as a keyboard, a keypad, a touch screen, a microphone, a digital camera, and/or some other suitable input device. External device(s) 416 can also include portable computer readable storage media such as, for example, thumb drives, portable optical or magnetic disks, and memory cards. Software and data used to practice embodiments of the present invention, e.g., QA generation program 106 and database 112 on server computer 104, can be stored on such portable computer readable storage media and can be loaded onto persistent storage 408 via I/O interface(s) 412. I/O interface(s) 412 also connect to display 418.

Display 418 provides a mechanism to display data to a user and may be, for example, a computer monitor. Display 418 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing descriptions of the various embodiments of the present invention have been presented for purposes of illustration and example, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
receiving, by one or more computer processors, a corpus of text;
extracting, by one or more compute processors, one or more key concepts from the corpus of text;
based on the one or more key concepts, generating, by one or more computer processors, one or more questions associated with the key concepts, wherein the one or more key concepts are answers to the one or more generated questions; and
displaying, by one or more computer processors, the one or more generated questions and the answers to the one or more generated questions.

2. The computer-implemented method of claim 1, further comprising:
preparing, by one or more computer processors, the corpus of text.

3. The computer-implemented method of claim 2, wherein preparing the corpus of text includes at least one of parsing the corpus into one or more individual pages, parsing the corpus into sections of pages, and cleaning the corpus.

4. The computer-implemented method of claim 1, wherein extracting the one or more key concepts from the corpus of text is based on a pedagogical template.

5. The computer-implemented method of claim 4, wherein the pedagogical template includes one or more categories, and wherein the one or more categories include: a character, a setting, a feeling, an action, a causal relationship, an outcome resolution, and a prediction.

6. The computer-implemented method of claim 1, wherein extracting the one or more key concepts from the corpus of text further comprises:
processing, by one or more computer processors, the corpus of text through a bidirectional long short term memory (LSTM) model.

7. The computer-implemented method of claim 1, wherein generating the one or more questions associated with the key concepts further comprises:
executing, by one or more computer processors, an artificial neural network, wherein the artificial neural network includes a bidirectional encoder and an autoregressive decoder.

8. A computer program product comprising:
one or more computer readable storage media and program instructions collectively stored on the one or more computer readable storage media, the stored program instructions comprising:
program instructions to receive a corpus of text;
program instructions to extract one or more key concepts from the corpus of text;
based on the one or more key concepts, program instructions to generate one or more questions associated with the key concepts, wherein the one or more key concepts are answers to the one or more generated questions; and
program instructions to display the one or more generated questions and the answers to the one or more generated questions.

9. The computer program product of claim 8, the stored program instructions further comprising:
program instructions to prepare the corpus of text.

10. The computer program product of claim 9, wherein the program instructions to prepare the corpus of text includes at least one of parsing the corpus into one or more individual pages, parsing the corpus into sections of pages, and cleaning the corpus.

11. The computer program product of claim 8, wherein the program instructions to extract the one or more key concepts from the corpus of text are based on a pedagogical template.

12. The computer program product of claim 11, wherein the pedagogical template includes one or more categories, and wherein the one or more categories include: a character, a setting, a feeling, an action, a causal relationship, an outcome resolution, and a prediction.

13. The computer program product of claim 8, wherein the program instructions to extract the one or more key concepts from the corpus of text comprise:
program instructions to process the corpus of text through a bidirectional long short term memory (LSTM) model.

14. The computer program product of claim 8, wherein the program instructions to generate the one or more questions associated with the key concepts comprise:
program instructions to execute an artificial neural network, wherein the artificial neural network includes a bidirectional encoder and an autoregressive decoder.

15. A computer system comprising:
one or more computer processors;
one or more computer readable storage media;
program instructions collectively stored on the one or more computer readable storage media for execution by at least one of the one or more computer processors, the stored program instructions comprising:
program instructions to receive a corpus of text;
program instructions to extract one or more key concepts from the corpus of text;
based on the one or more key concepts, program instructions to generate one or more questions associated with the key concepts, wherein the one or more key concepts are answers to the one or more generated questions; and
program instructions to display the one or more generated questions and the answers to the one or more generated questions.

16. The computer system of claim 15, the stored program instructions further comprising:
program instructions to prepare the corpus of text.

17. The computer system of claim 16, wherein the program instructions to prepare the corpus of text includes at least one of parsing the corpus into one or more individual pages, parsing the corpus into sections of pages, and cleaning the corpus.

18. The computer system of claim 15, wherein the program instructions to extract the one or more key concepts from the corpus of text are based on a pedagogical template.

19. The computer system of claim 15, wherein the program instructions to extract the one or more key concepts from the corpus of text comprise:
program instructions to process the corpus of text through a bidirectional long short term memory (LSTM) model.

20. The computer system of claim 15, wherein the program instructions to generate the one or more questions associated with the key concepts comprise:
program instructions to execute an artificial neural network, wherein the artificial neural network includes a bidirectional encoder and an autoregressive decoder.
